(19) United States
(12) Patent Application Publication
(10) Pub. No.: US 2015/0288412 A1
(43) Pub. Date: Oct. 8, 2015

(54) Harmonic Rejection Mixer

(71) Applicant: Broadcom Corporation, Irvine, CA (US)

(72) Inventors: Juhani Kalervo AALTO, Espoo (FI); Jouni Kristian KAUKOVUORI, Vantaa (FI); Jari Johannes HEIKKINEN, Helsinki (FI); Markus NENTWIG, Helsinki (FI); Alain LAVAURE, Noyal sur Vilaine (FR)

(73) Assignee: Broadcom Corporation, Irvine, CA (US)

(21) Appl. No.: 14/244,358

(22) Filed: Apr. 3, 2014

(51) Int. Cl. H04B 1/403; H04B 1/44

(52) U.S. Cl. CPC H04B 1/403; H04B 1/44

(57) ABSTRACT

An apparatus, which includes a local oscillator configured to oscillate at a carrier frequency and having output ports and configured to provide a signal of a respective phase at each of the output ports, wherein the respective phases are different from each other,
a plurality of branches, each branch corresponds to one of the output ports and includes a mixer unit, where for each branch, the signal of the respective phase is applied to an input port of the mixer unit and the mixer unit is configured to modulate a baseband signal by the signal of the respective phase of the local oscillator to obtain, at its output port, a respective modulated signal and;
a combiner configured to add the modulated signals from the branches to obtain a total signal to be output to a load; and
at least one of the branches includes a multi-switch.

### FIELD OF THE INVENTION

The present description relates to an apparatus and a method related to radio transceiver. More particularly, the present description relates to an apparatus and a method related to harmonic rejection mixers in receiver and/or transmitter.

### BACKGROUND

Abbreviations
3GPP 3^{rd} Generation Partnership Project
AGC Automatic Gain Control
BB Baseband
BTS Base Transceiver Station
C-IM Counter-Intermodulation
CDMA Code Division Multiple Access
CMOS Complementary Metal Oxide Semiconductor
CTRL Control
DAC Digital to Analog Converter
dB Decibel
dBc Decibels relative to the carrier
DC Direct Current
EDGE Enhanced Data Rates for GSM Evolution
f-C-IM Folded Counter-Intermodulation
Gm Transconductance
GSM Global System for Mobile Communications
HD Harmonic Distortion
HR Harmonic Rejection
IF Image Frequency
IM Intermodulation
ISM Industrial, Scientific and Medical Band
ISR Input Signal Rejection
LAN Local Area Network
LC Inductor-Capacitor
LO Local Oscillator
LPF Low Pass Filter(ed)
LTE Long-Term Evolution
LTE-A LTE advanced
MOS Metal Oxide Semiconductor
MOSFET Metal Oxide Semiconductor Field Effect Transistor
NMOS N-type MOS
PA Power Amplifier
PDA Personal Digital Assistant
PGA Programmable Gain Amplifier
PMOS P-type MOS
PVT Process, Voltage, Temperature
RF Radio Frequency
RFIC Radio Frequency Integrated circuit
RX Receive(r)
sqrt square root
TX Transmit(ter)
UE User Equipment
UL Uplink
UMTS Universal Mobile Telecommunication Service
W Width
WLAN Wireless LAN

In receivers and transmitters, the mixer converts signals from/to LO frequency and its harmonics. Typically mixer uses double balanced structure, and therefore, the level of even-order harmonics at mixer output is very low. However, odd order harmonics of LO are not rejected by the double balanced structure. In modern CMOS processes implementing passive mixer topologies require rail-to-rail clocking waveforms of LO with very high harmonic content. The LO harmonic causes several unwanted features in TX and RX as discussed below.

### Transmitter:

FIG. 1 shows a typical UE LTE UL output spectrum, wherein the wanted signal appears at −1×IF away from the LO, and in which several unwanted components appear. In addition to LO leakage and image signal, RFIC transmitter generates a counter-IM3 (C-IM3) product that appears +3×IF frequency away from the LO (at opposite side of the LO compared to the wanted signal). In addition to C-IM3 (also named H3 hereinafter), the Power Amplifier (PA) causes folded-C-IM3 due to intermodulation. Then, the wanted signal and C-IM3 product generate a folded-C-IM3, which appear at −5×IF frequency away from the LO (now, at the same side as the wanted signal, also named f-H5 hereinafter).

FIG. 2 shows a radio transmitter in which C-IM3 may occur. The baseband signal (after being digital-analog converted by DAC and typically also filtered), is mixed with the LO frequency at 0° phase and 90° phase at I-path and Q-path, respectively. These signals are added. The added signal is amplified by PGA and PA, and—in some cases after being modulated—transmitted through an antenna.

C-IM3 can be generated in such a radio transmitter by two mechanisms (see FIG. 2):

### 1. C-IM3 Due to BB HD3:

The baseband nonlinearity generates third-order harmonic distortion in I/Q path. These BB HD3 signals are directly up-converted by the modulator to C-IM3 frequency (f_{LO}+3f_{BB}), which is at the opposite side of the wanted signal.

2. C-IM3 Due to the Intermodulation between the Wanted Signal and RF HD3:

The modulator outputs the wanted signal (f_{LO}−f_{BB}) as well as RF HD3 (3f_{LO}+f_{BB}) due to LO 3^{rd}-order harmonics. These signals are subjected to nonlinearities of the PGA after the mixer. The 3^{rd}-order intermodulation product between the wanted signal and RF HD3 is then located at (3f_{LO}+f_{BB})−2(f_{LO}−f_{BB})=f_{LO}+3f_{BB}.

In addition to C-IM3 problem, harmonic components cause also problems when TX output signal is upconverted to bandwidth where it folds to RX band. An example of this behavior is when TX is transmitting at band 17 then its 3^{rd} harmonic folds to RX band 4 which greatly deteriorates receiver performance.

The latter C-IM3 mechanism is usually overcome using harmonic rejection mixers. Then the 3^{rd} harmonic is rejected (or greatly attenuated in practice) and C-IM3 term does not occur due to LO harmonic. Using these harmonic rejection mixers means that there are separate dedicated mixer cells for each LO phase. Accordingly, the area of the harmonic rejection mixer is significantly larger because of three different mixer cores required to produce harmonic rejection.

### Receiver:

In receiver side, the biggest problem due to squarewave LO is the conversion from LO 3^{rd} harmonic to the baseband. The down-converted blocker signal from 3^{rd} harmonic can degrade the signal-to-noise-ratio of the desired signal, or even block the reception altogether via compression or intermodulation.

For example, cellular radio operating around 800 MHz vicinity (e.g. Band 20, DL: 791-821 MHz, marked as LO_{RX, B20}) can down-convert signal from 2.4-GHz frequency area where other radios, e.g. WLAN, operates (marked as 2.4 GHz ISM, see FIG. 3). It is observed that the LO 3^{rd} harmonic down-converts also WLAN component from 2.4-GHz frequency area and thus desensitizes the wanted DL component. The ratio of downconversion gain from undesired frequency to wanted frequency is measured with input-signal-rejection (ISR), i.e. the better the ISR performance is, the larger the unwanted component can be compared to the wanted one.

Correspondingly, DLs operating around 1700-1900 MHz range (e.g. Bands 3 and 9) can get corrupted from down-converted 5-GHz WLAN signal.

Thus in both, transmitter and receiver, the LO 3^{rd} harmonic component causes undesired features.

Harmonic rejection mixer principle was proposed by Weldon et al in “A 1.75-GHz Highly Integrated Narrow-Band CMOS Transmitter With Harmonic-Rejection Mixers”, IEEE JOURNAL OF SOLID-STATE CIRCUITS, VOL. 36, NO. 12, December 2001. The harmonic rejection is based on the harmonics of square waves. When three ideal square waves are summed (with one of them (f₂(t)) scaled by sqrt(2)), the third and fifth harmonics are cancelled. As the summed waveform shows, it is a “reconstruction” of a sinusoidal signal based on square waves.

At FIG. 4, it is shown how emulated sinusoidal signal can be constructed from three different LO phases. On the left side is shown differential signal for duty cycle 50 percent and on the right side the same is shown for duty cycle 25 percent. FIG. 4 shows only how P signal is constructed. M signal is constructed in similar way, wherein LO phases are shifted by 180 degrees.

A basic block diagram of traditional H3 rejection mixer is shown on the left side of FIG. 5 (TX mixer). Here, a single mixer (cell) is used for each LO-phase (0°, 45°, 90°) to produce the wanted H3 rejection at the output of the mixer I_tot. In the 45° path the mixed signal is amplified by sqrt(2). The three paths are in parallel, and their currents are summed up to obtain I_tot.

One implementation to weight the RF paths is shown on the right side of FIG. 5 (RX mixer). Each path comprises a transconductor Gm. The transconductors (Gm) are typically differential (as shown in the right bottom insert of FIG. 5 for the transconductor amplifying the summed up signal of the three paths), but in the main part of the right side of FIG. 5, only single-ended paths are shown for simplicity. The gain of the transconductor of the 45° path is sqrt(2)-times that of the other phases.

In one or all of the paths, a switch (MOSFET) controlled at its gate by the respective LO phase signal may comprise a double-balanced mixer cell, as shown in the insert on the upper right of FIG. 5. Thus, the LO has differential phases, i.e. switches marked with LO_{—}0 and LO_{—}45 are driven with LO signals having phases of 0 and 180 degrees and 45 and 225 degrees, respectively. The transconductor Gm could be replaced by a weighted resistor R, or a multiplier could be implemented with both Gm and R.

Another implementation example of the prior art (according to the basic principle outlined on the left side of FIG. 5) is shown at FIG. 6. Each of the three paths is driven by a respective constant current source and comprises two MOSFETs. BB and the respective phase of LO are applied to the gate of the MOSFETs Mbb and Mlo, respectively, of each path. The widths of the MOSFETs of the LO-45 phase are scaled by sqrt(2) when compared to the widths of LO-0 and LO-90 phase mixer in order to mimic sinusoidal frequency response which eliminates 3^{rd} harmonic. In each path, MOSFET MLO is driven in the saturation regime (switched on/off) by the respective LO phase, and MOSFET Mbb is driven in the proportional range by the baseband signal BB. In addition, the control signal to Mbb may be enabled and disabled by the signal “en”.

FIG. 7 shows some other conventional mixer topologies (schematically on top, an implementation example at the bottom). These mixers may be used in a path of the harmonic rejection mixers of FIGS. 5 and 6. As can be seen on the top, in these topologies, BB and (one phase of) LO are mixed to RF.

The mixer shown on the left corresponds to the mixers of each path of FIG. 6 except that the enabling switch (signal “en”) is omitted. In the middle, the sequence of Mlo and Mbb is changed. Note that in these two configurations, instead of the constant current source of FIG. 6, ground level is applied. These paths have to be biased by a bias voltage via a load (not shown) connected to the RF terminal.

On the right side of FIG. 7, it is shown that BB may be connected directly to a source or drain of Mlo, wherein LO is connected to the gate, and RF is output from the other of source and drain.

### BRIEF DESCRIPTION OF THE DRAWINGS

Further details, features, objects, and advantages are apparent from the following detailed description of the preferred embodiments of the present invention which is to be taken in conjunction with the appended drawings.

FIG. 1 shows a UE LTE UL output spectrum.

FIG. 2 shows a radio transmitter where C-IM3 may occur.

FIG. 3 shows positions of signals in different bands and their down-conversion.

FIG. 4 shows an emulation of a sinusoidal wave from weighted square waves for different duty cycles.

FIG. 5 shows a conventional harmonic rejection mixer.

FIG. 6 shows another conventional harmonic rejection mixer.

FIG. 7 shows several options to realize a path of a harmonic rejection mixer.

FIGS. 8A to 8C show several harmonic rejection mixers according to embodiments.

FIG. 9 shows the harmonic rejection mixer of FIG. 8C integrated with a load and a bias voltage.

FIG. 10 shows a configurable harmonic rejection mixer according to an embodiment.

FIG. 11 shows a configurable harmonic rejection mixer, which is an apparatus according to an embodiment.

FIG. 12 shows a configurable harmonic rejection mixer according to an embodiment.

FIG. 13 shows a configurable harmonic rejection mixer, which is an apparatus according to an embodiment.

FIG. 14 shows a configurable harmonic rejection mixer according to an embodiment.

FIG. 15 shows a configurable harmonic rejection mixer, which is an apparatus according to an embodiment.

FIG. 16 shows a LO signal.

FIG. 17 shows LO phasing and the rise/fall time effect.

FIG. 18 shows a simulation of H3 rejection with duty cycle 50% under consideration of the rise/fall time effect.

FIG. 19 shows a simulation of H5 rejection with duty cycle 50% under consideration of the rise/fall time effect.

FIG. 20 shows a simulation of H3 rejection with duty cycle 25% under consideration of the rise/fall time effect.

FIG. 21 shows a simulation of H5 rejection with duty cycle 25% under consideration of the rise/fall time effect.

FIG. 22 shows a simulation of wanted signal level for different rise/fall times and different duty cycles.

FIG. 23 shows a feedback loop according to an embodiment of the invention.

FIG. 24 shows an apparatus for monitoring LO duty cycle variation.

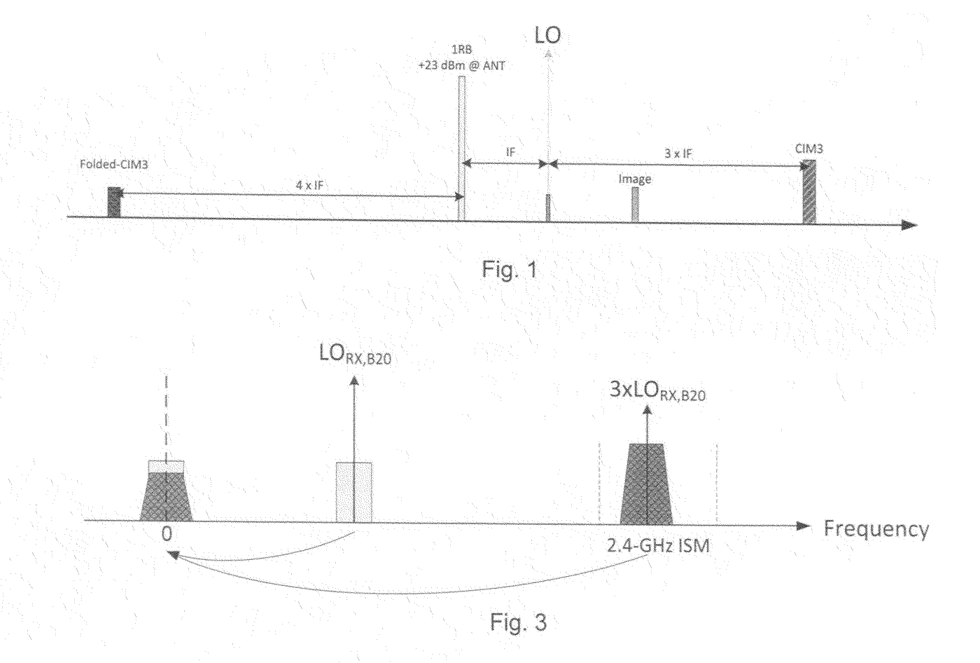

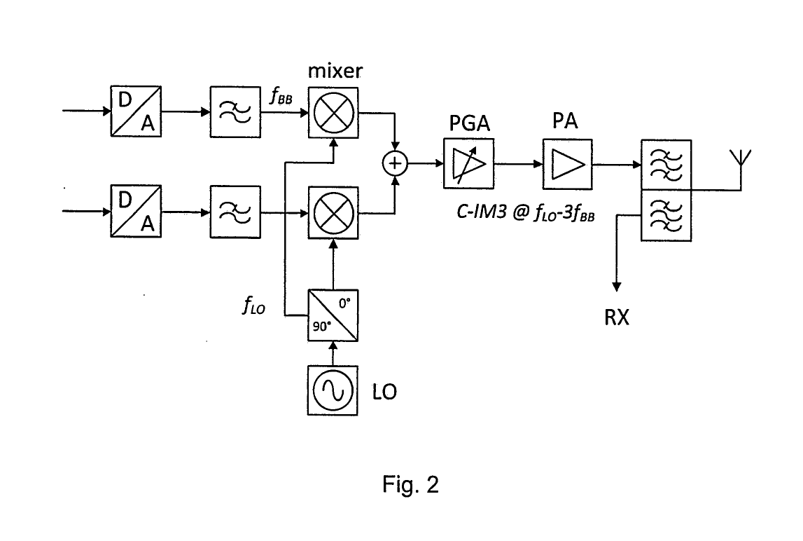

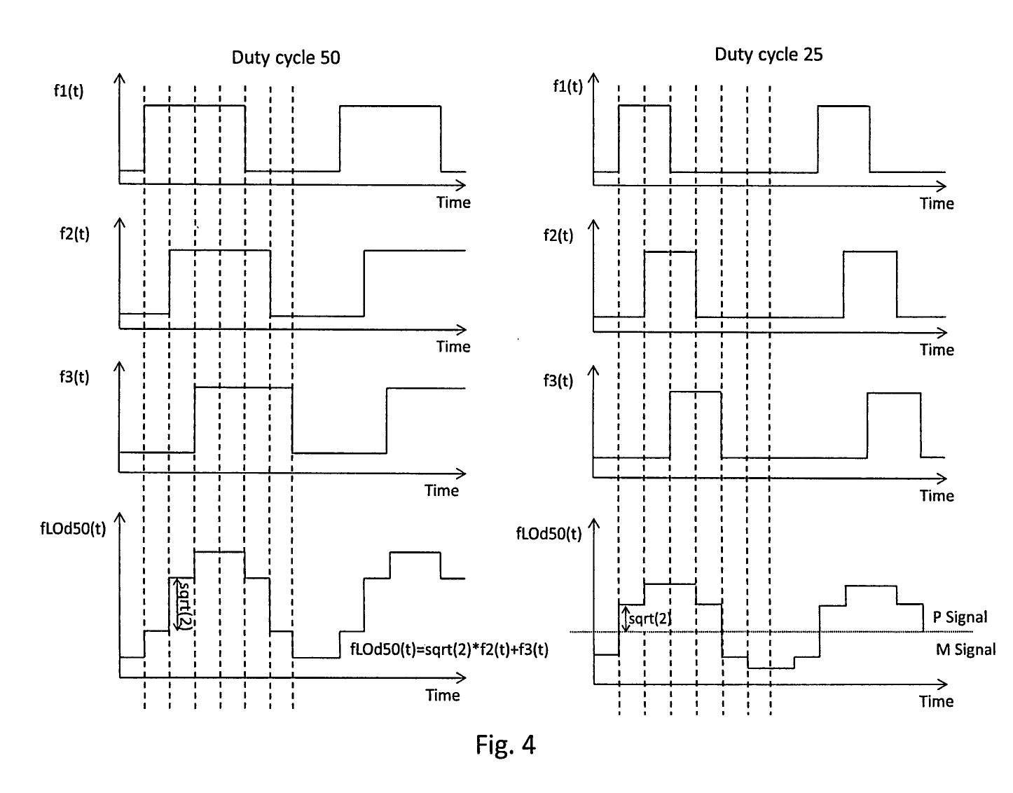

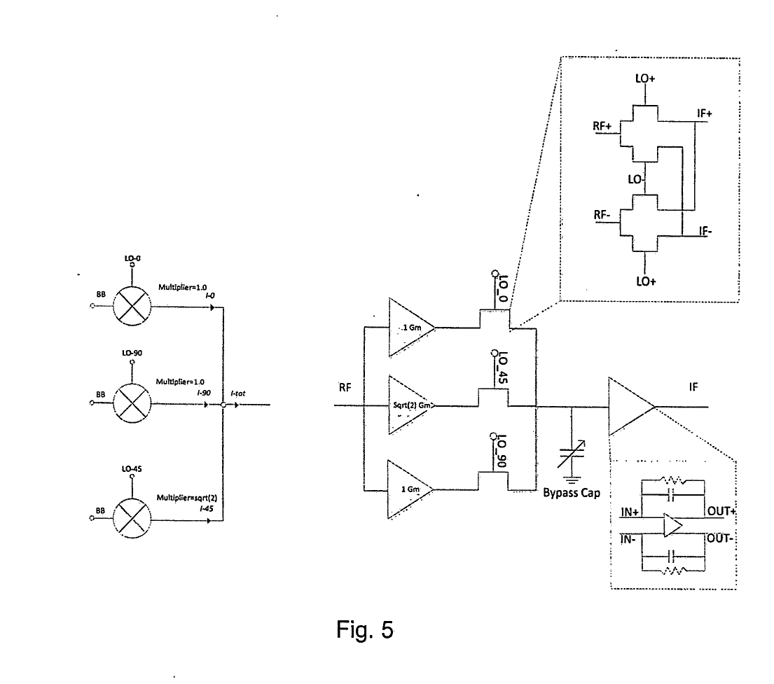

### DETAILED DESCRIPTION OF CERTAIN EMBODIMENTS

It is an object of the present invention to improve the prior art.

According to a first aspect of the invention, there is provided an apparatus, comprising a local oscillator configured to oscillate at a carrier frequency and having plural output ports, wherein the local oscillator is configured to provide a signal of a respective phase at each of the plural output ports, wherein the respective phases are different from each other; a plurality of branches, wherein each branch corresponds to one of the plural output ports and comprises a mixer unit, wherein, for each branch, the signal of the respective phase is applied to an input port of the mixer unit and the mixer unit is configured to modulate a baseband signal by the signal of the respective phase of the local oscillator to obtain, at its output port, a respective modulated signal and; a combiner configured to add the modulated signals from the branches to obtain a total signal to be output to a load; wherein at least one of the branches comprises a multi-switch, wherein for each of the at least one multi-switches: an output terminal of the multi-switch is connected to the respective input port of the mixer unit, the multi-switch comprises plural input terminals and is configured to connect one of the input terminals to the output terminal and to disconnect the others of the input terminals from the output terminal, and each of the input terminals is connected to one of the output ports of the local oscillator.

According to a second aspect of the invention, there is provided a method applied to a monitored apparatus, wherein the monitored apparatus comprises plural branches and each branch is adapted to modulate a baseband signal with a signal of a local oscillator of a respective phase to obtain a respective modulated signal of the branch and the respective phases are different from each other, a combiner to combine the modulated output signals of the branches into a total signal, and at least one of the branches comprises a weighting means adapted to weight the respective modulated signal, wherein the method comprises detecting if the total signal comprises a frequency component of a frequency different from the carrier frequency with a level higher than a predefined level; adapting, by the weighting means, the modulated signal of the at least one branch comprising the weighting means in order to reduce the level of the frequency component. The method may be a control method. The weighting means may be a weighting element or a weighting circuitry.

According to a third aspect of the invention, there is provided an apparatus, comprising plural branches, wherein each branch is adapted to modulate a baseband signal with a signal of a local oscillator of a respective phase to obtain a respective modulated signal of the branch and the respective phases are different from each other, and at least one of the branches comprises a weighting means adapted to weight the respective modulated signal; a combiner adapted to combine the modulated output signals of the branches into a total signal, a detecting means adapted to detect if the total signal comprises a frequency component of a frequency different from the carrier frequency with a level higher than a predefined level; a control means adapted to control the weighting means in order to reduce the level of the frequency component below the predefined level. The detecting means may be a detector. The control means may be a controller. The weighting means may be a weighting element or a weighting circuitry.

According to a fourth aspect of the invention, there is provided a method applied to an apparatus, wherein the apparatus comprises plural branches, wherein each branch is adapted to modulate a baseband signal with a signal of a local oscillator of a respective phase to obtain a respective modulated signal of the branch and the respective phases are different from each other, and at least one of the branches comprises a weighting means adapted to weight the respective modulated signal; a combiner adapted to combine the modulated output signals of the branches into a total signal, and the method comprises detecting if the total signal comprises a frequency component of a frequency different from the carrier frequency with a level higher than a predefined level; and controlling the weighting means in order to reduce the level of the frequency component below the predefined level. The weighting means may be a weighting element or weighting circuitry.

According to a fifth aspect of the invention, there is provided an apparatus, comprising a plurality of branches, wherein each branch comprises a mixer unit, wherein each of the mixer units is configured to modulate a baseband signal by a signal of a respective phase of a local oscillator; a combiner configured to add the signals from the branches to obtain a total signal to be output to a load; wherein at least one of the branches comprises a gain control transistor, wherein one of a source and a drain of the gain control transistor is connected to the respective mixer unit, and the other of the source and the drain of the gain control transistor is connected to the combiner.

According to some embodiments of the invention, at least one of the following advantages may be achieved:
semiconductor area usage is enhanced;
flexibility with respect to balancing harmonic rejection and output power is enhanced;
H3/H5 rejection is enhanced;
new methods are introduced to improve H3/H5 rejection.

It is to be understood that any of the above modifications can be applied singly or in combination to the respective aspects to which they refer, unless they are explicitly stated as excluding alternatives.

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that a recited apparatus is configured to perform the corresponding method, although in some cases only the apparatus or only the method are described.

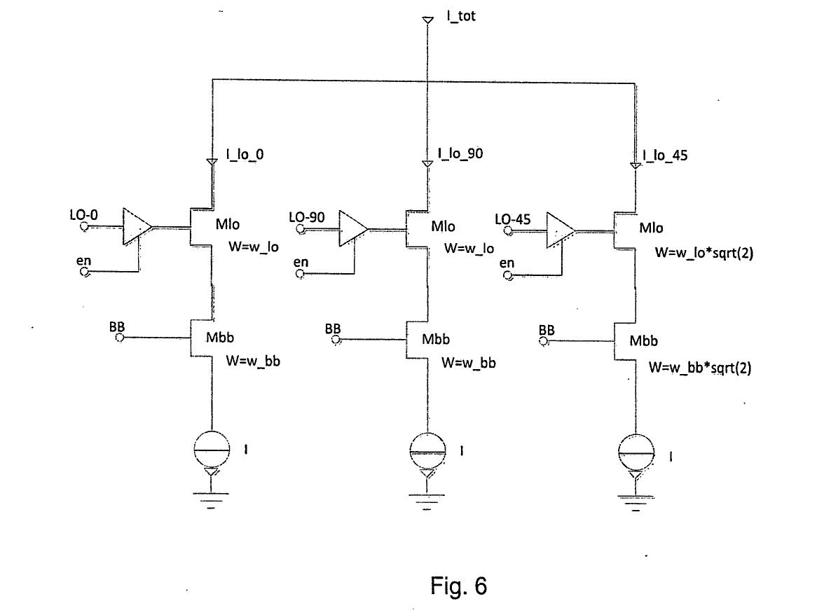

A disadvantage of the harmonic rejection mixer shown in FIG. 6 is that it has strong dependency on the duty cycle of the LO signal because all the LO phases are connected directly to the gate of the respective switch transistor Mlo, wherein the drains of the switch transistors are directly connected with each other. This limits how good C-IM3 rejection is achievable and it also means that the C-IM3 rejection will decrease when the rise/fall time of the LO signal will increase.

Also, 45-degree phase is always present. In some cases, there may be bands or resource block allocations where extremely good C-IM3 or ISR3 performance is not needed. Thus, the 45-degree LO generation might not be needed. Since the 45-degree path consumes power, in these cases it might be advantageous not to have the 45-degree path.

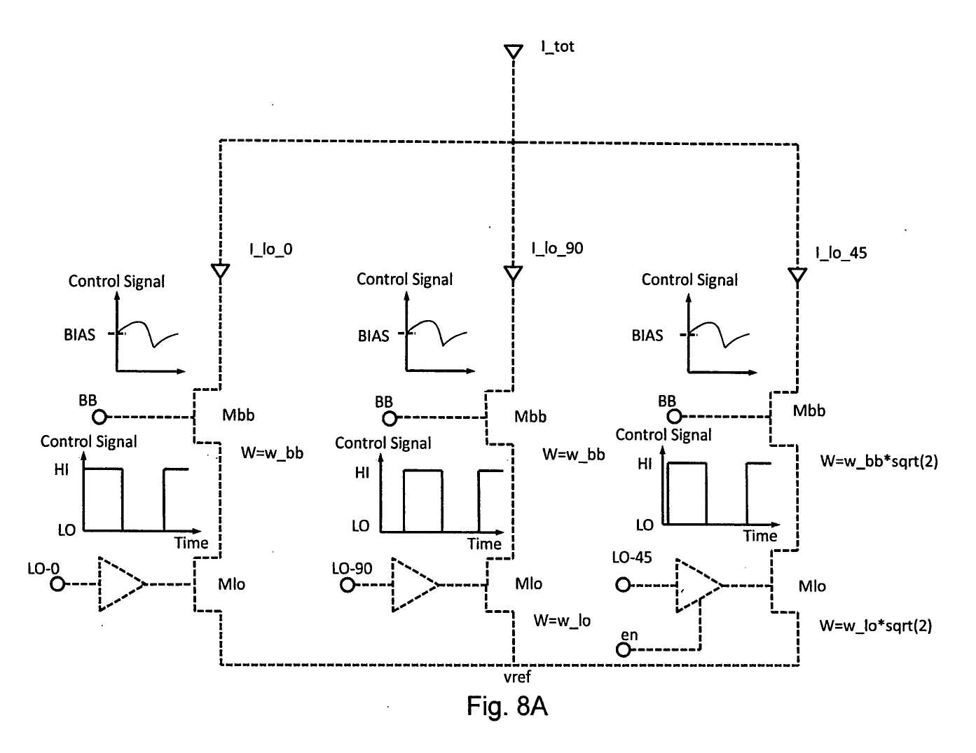

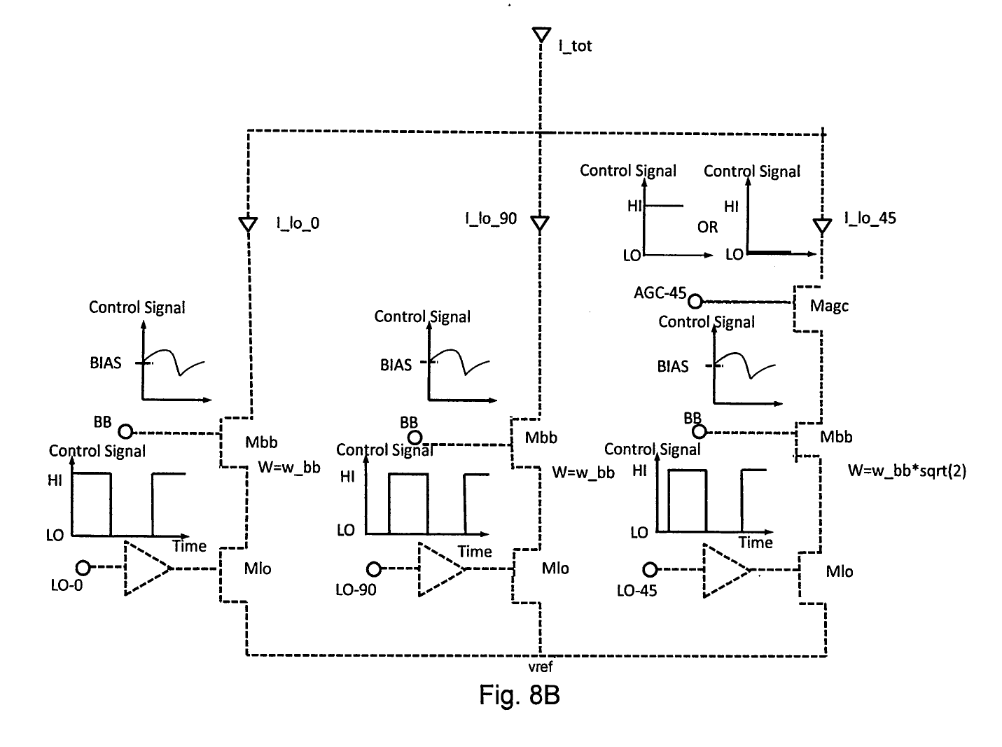

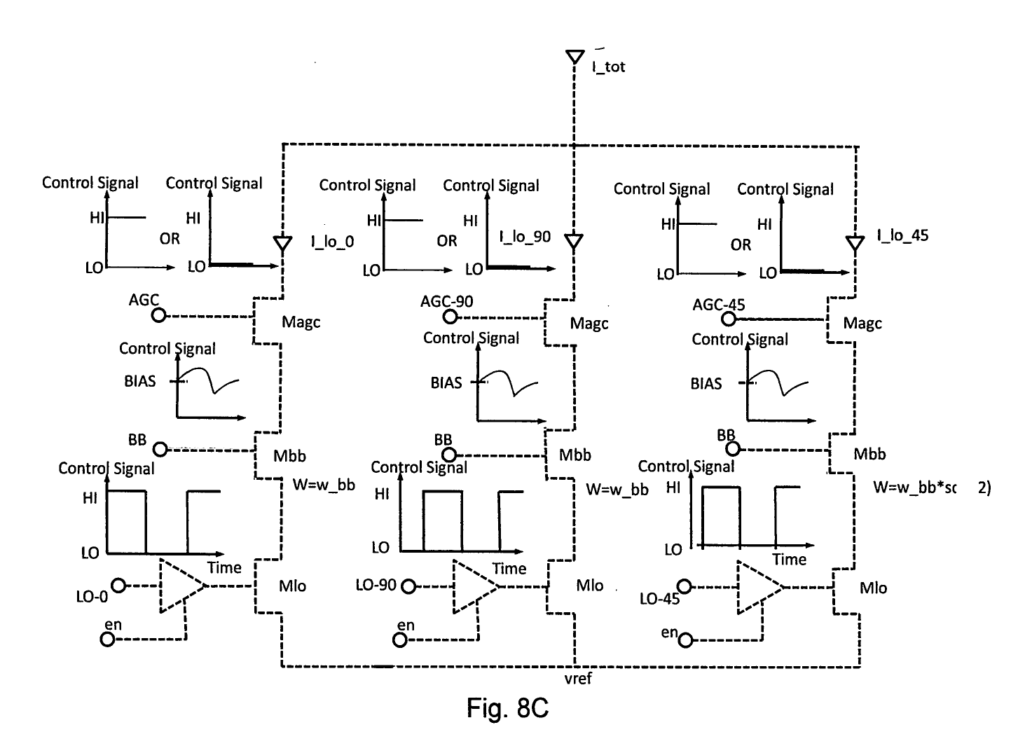

In FIG. 8A-C are shown several harmonic rejection mixers according to embodiments that have significantly better C-IM3 rejection performance versus duty cycle variation. The structures shown in FIG. 8A-C basically correspond to those of FIG. 6.

The harmonic rejection mixers comprise three paths. Each path comprises two or three MOSFETs in the sequence Mlo, Mbb and optionally Magc from the voltage terminal V_{ref} to the output terminal I_tot, to which a load (not shown in FIG. 8) may be connected. The source or drain of Mlo is connected to V_{ref}, and the other one of source and drain of Mlo is connected to source or drain of Mbb. The other one of source and drain of Mbb is connected to the connection point of the three paths (output terminal I_tot), or, if Magc is present in the path, to source or drain of Magc. In the latter case, the other one of source and drain of Magc is connected to output terminal I_tot.

The three paths are connected in parallel between the terminals V_{ref} and I_tot.

In each path, Mlo is controlled, at its gate, by a respective phase (e.g. 0°, 45°, or 90°) of LO. Mlo acts as a switch, i.e. the control signal switches Mlo on or off, as indicated by the rectangular control signal in the corresponding inserts. In some embodiments, one or more of the respective phase signal may be enabled or disabled by the signal “en” (e.g. FIGS. 8A and 8C), but in other embodiments, this option is not present (e.g. FIG. 8B).

In each path, Mbb is controlled, at its gate, by BB. Mbb operates in the amplifying (or linear) mode, as shown by the control signal in the corresponding inserts. The BB control signal may be biased.

The signal of the 45° path is enhanced by sqrt(2) compared to the two other paths. This is achieved by a transistor width which is increased by sqrt(2) compared to the corresponding transistor width of the other two paths. In some embodiments, only the width of Mbb of the 45° path is increased by sqrt(2) (e.g. shown in FIGS. 8B and 8C), while in other embodiments, each transistor width of the 45° path is increased by sqrt(2) compared with the width of the corresponding transistor of the other paths (e.g. FIG. 8A).

Magc, if present, is controlled, at its gate, by a binary control signal AGC. Thus, Magc may be switched on or off. During operation, if harmonic rejection is required, Magc is typically switched on.

In FIG. 8A, there is no Magc, in FIG. 8B, there is a single Magc (in this case, but not limiting, in the 45° path), and in FIG. 8C, a respective Magc is provided in each of the three paths. Each of the Magc's of the different paths may have unity amplification (or about unity amplification). If there are Magc's in all three paths, the amplification of them may be different from 1, but it should preferably be (about) the same for the three Magc's.

Through the insertion of Magc in one or more of the paths, the isolation between the different Mlo transistors is improved. Thus, harmonic rejection may be increased.

In addition, Magc may be used to adapt the levels of the signals such that harmonic rejection is improved. Since the 0° and 90° path should have the same amplification, if there is a single Magc only, it should be inserted preferably into the 45° path. Correspondingly, if there are two Magc's, they should be inserted preferably into the 0° and 90° paths. Thus, by different amplification factors of the Magc or Magc's, for example, manufacturing tolerances may be compensated.

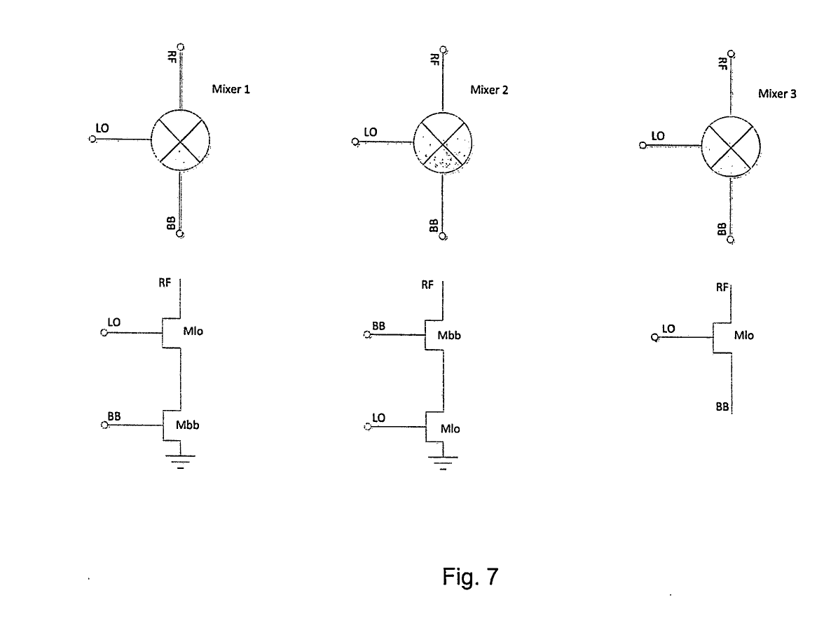

The combination of Mlo and Mbb in each path may be replaced by one of the other mixer topologies shown in FIG. 7. In other words, an Magc transistor may be added to any of the mixers shown in FIG. 7 such that, in the harmonic rejection mixer, Magc is located between the mixer and the output terminal I_tot. Thus, Magc provides the same advantages as each of the Magc's shown in FIG. 8.

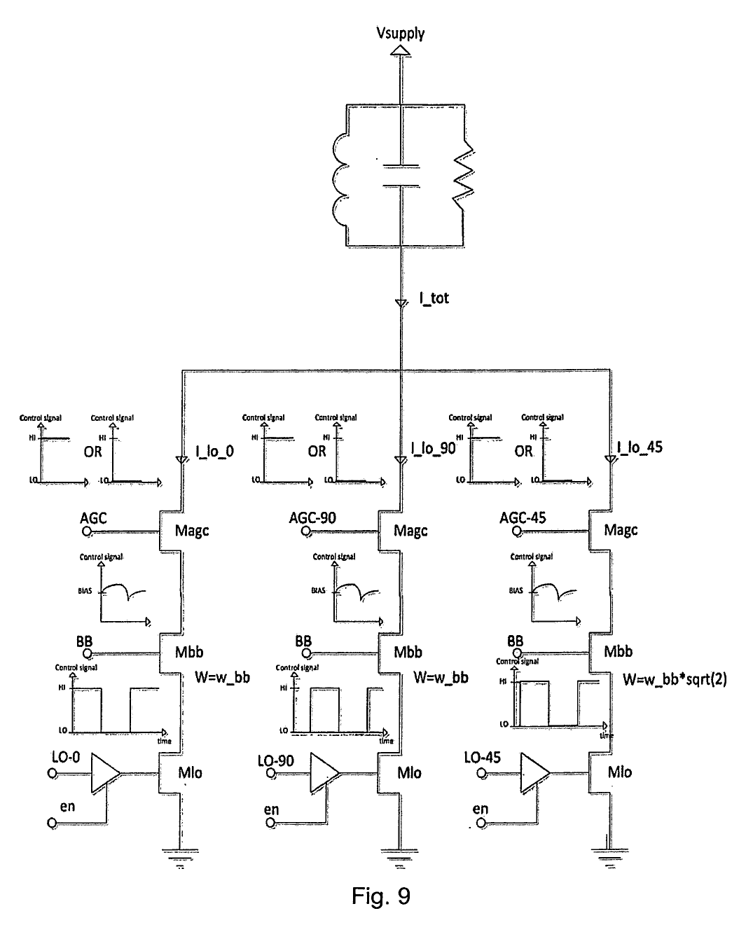

Note that the harmonic rejection mixers of FIGS. 8A to 8C are driven by a bias voltage instead of the constant current sources as according to FIG. 6. FIG. 9 shows, as an example embodiment, the harmonic rejection mixer of FIG. 8C together with load and bias voltage. The added outputs of the three paths are connected at the terminal I_tot to a load represented by an oscillation circuit. A bias voltage V_{supply} is applied across the load and each of the three paths of the harmonic rejection mixers. Note that “ground” at the end of each of the paths of the harmonic rejection mixer may be replaced by another fixed potential V_{ref}, which should be different from V_{supply}. Correspondingly, the harmonic rejection mixers of FIGS. 8A, 8B and of the other embodiments of the description may be connected to a load and biased by a bias voltage.

Alternatively, each of the paths of any one of the harmonic rejection mixers of FIG. 8 and the other embodiments of the description may be driven by a respective constant current source, correspondingly to the configuration shown in FIG. 6.

Furthermore, in all of the harmonic rejection mixers of FIG. 8, a better C-IM3 rejection than according to FIG. 6 is achieved by having the LO switching transistor Mlo as the lowest transistor in the three transistor cascade connection (closest to the reference potential V_{ref} or to the constant current source, depending on implementation). Therefore, the Mlo's have much better isolation between each other which helps to reject C-IM3 harmonics.

In case a C-IM3 specification (or another harmonic rejection specification such as H3, H5, ISR3, ISR5) is to be fulfilled in a band without using mixer's C-IM3 rejection property (i.e. a specified maximum level of C-IM3 is not exceeded) but more output power would be required, conventionally more mixer cells in parallel are used.

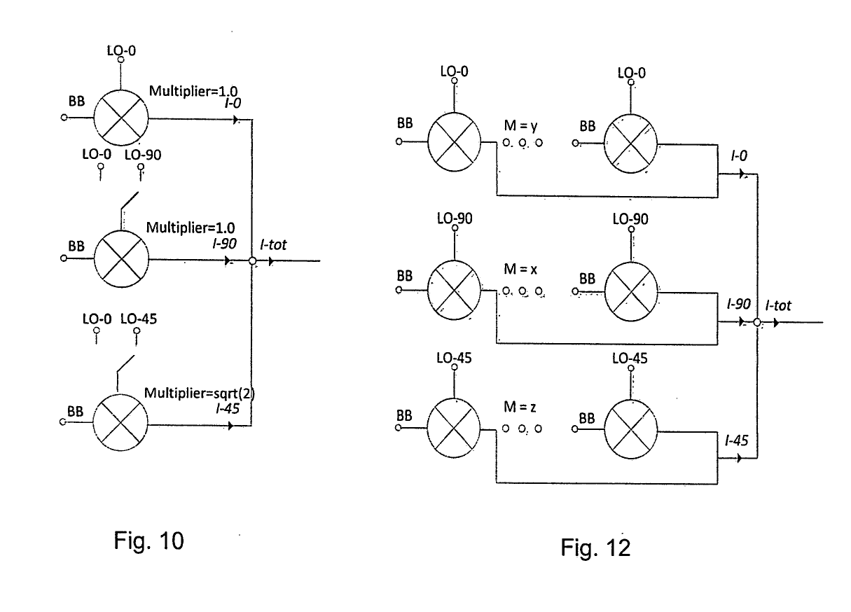

FIG. 10 shows an embodiment of the invention. It is shown a block diagram of a way to reuse one or more of the mixer cells of a harmonic rejection mixer to drive same phase in those mixer cells. In the embodiment shown in FIG. 10, the top mixer cell is driven by LO phase 0°. The middle mixer cell may be driven by LO phase 0° or LO phase 90°, depending on a position of a switch. The lower mixer cell may be driven by LO phase 0° or LO phase 45°, depending on a position of another switch. The signal of the lower path is amplified by sqrt(2) compared to the other paths. Thus, the following combinations may be achieved depending on the needs:
0°, 90°, 45° (harmonic rejection mixer);
0°, 90°, 0°;
0°, 0°, 45°; and
0°, 0°, 0°.

In the last three combinations, the level of the 0° signal is amplified by 1+sqrt(2), 2, and 2sqrt(2), respectively.

The mixer cells of FIG. 10 may be any of those discussed with respect to FIGS. 6 to 8. In particular, none, one, two, or three of the mixer cells may comprise an AGC transistor. Thus, the gains of the signals may be further adapted to the needs. E.g., in the second and third combinations, equal levels of the 0° and 90° (45°) signals may be achieved by appropriate settings of the gains of the AGC transistors.

The configurable harmonic rejection mixer of FIG. 10 is useful in both TX and RX.

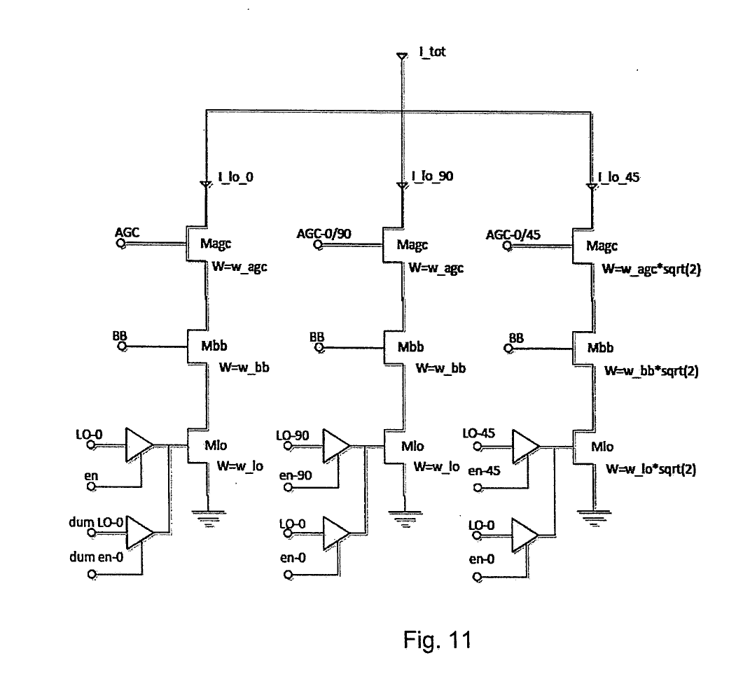

A detailed implementation example of the principle shown in FIG. 10 is shown in FIG. 11.

FIG. 12 shows another configurable harmonic rejection mixer. It is shown a way to implement weighting by sqrt(2) by using several mixer unit cells of a same amplification. Technically, the term “mixer unit cell” designates a mixer (cell) as those discussed with respect to FIGS. 6 to 8.

One, two, or three of the three paths of the harmonic rejection mixer comprise several mixer unit cells in parallel (in FIG. 12, each of the paths comprises several mixer unit cells, but this is not restricting). Each of the mixer unit cells of one path is driven by the same LO phase (top: 0°, middle: 90°, bottom: 45°). By adapting the number of parallel mixer unit cells in each of the paths, a desired ratio of the signal levels of the paths may be reached. E.g., if all the mixer unit cells are identical, a ratio of 1:1:sqrt(2) may be approximately achieved if the number M of mixer unit cells is 50:50:71 or a multiple thereof.

Preferably, all the mixer unit cells are identical. In particular, the transistors of all of the mixer unit cells may have equal widths. If all mixer unit cells are identical, matching will be better. However, in general, the unit cells do not need to be identical.

In embodiments with plural mixer unit cells in at least one path, harmonic rejection dependency on the LO signal's rise/fall time may be rather easily eliminated (see below).

The configurable harmonic rejection mixer with plural mixer unit cells in at least one path suits well for DAC style mixer cells in transmitters.

The number of mixer unit cells in each path may be fixed. Alternatively, the number of unit cells may be switchable. For example, some or all of the mixer unit cells may be switched on/off by an enabling signal which passes or blocks the respective LO phase from the Mlo transistor, as discussed with respect to FIGS. 6 and 8.

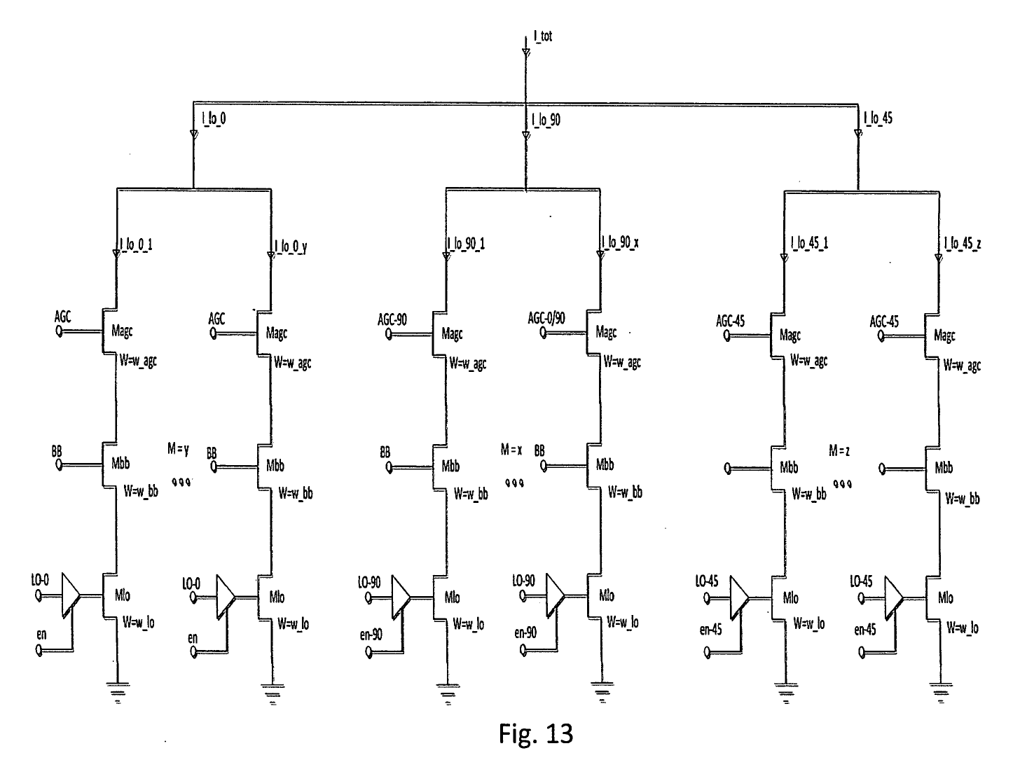

A detailed implementation example of the principle shown in FIG. 12 is shown in FIG. 13.

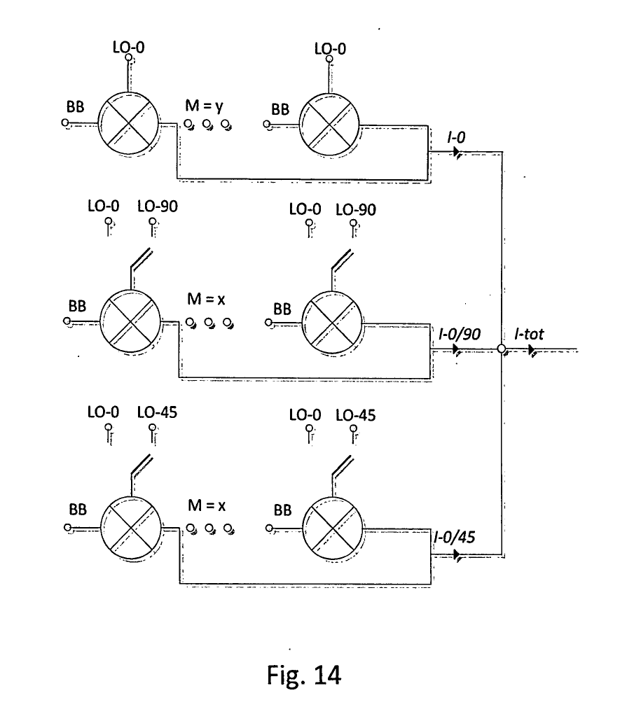

The concepts outlined with respect to FIGS. 10 and 12 may be combined, as shown in FIG. 14.

In FIG. 14, each of the three paths comprises several mixer unit cells, wherein each mixer unit cell of the middle and lower path may mix one of two different LO phases to BB (middle path: 0° and 90°; bottom path: 0° and 45°). Thus, the ratio of mixer unit cells for the three phases may be adapted according to the needs.

In general, in some embodiments, there are at least two mixer unit cells in one of the paths which may be driven by at least two different LO phases. That is, one two or three of the paths may each comprise two or more mixer unit cells which may be driven by two or three different LO phases. In some or all of the paths, each mixer unit cell may be driven by two or three different LO phases.

The mixer unit cells may be identical, or some of them may be different from the others. The number of mixer unit cells in each path may be the same or different from the others. Some or all of the mixer unit cells may be switched on/off, e.g. by an enabling signal.

The unit mixer cells of one path may be controlled by the same LO phase. However, in some embodiments, each of the unit mixer cells of one path may be controlled by its respective phase. In this case, the harmonic rejection mixer may be considered as comprising x+y+z parallel paths each with a single mixer unit cell, wherein x, y, and z are the respective numbers of unit cells in each of the three paths when considered as harmonic rejection mixer.

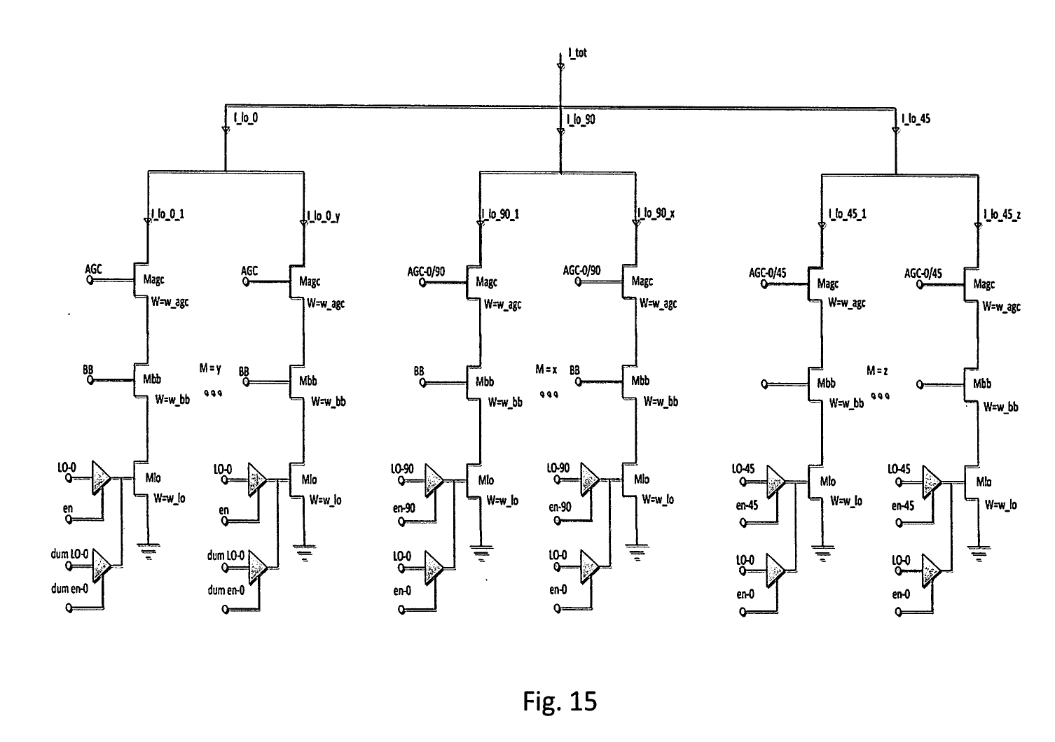

A detailed implementation example of the principle shown in FIG. 14 is shown in FIG. 15.

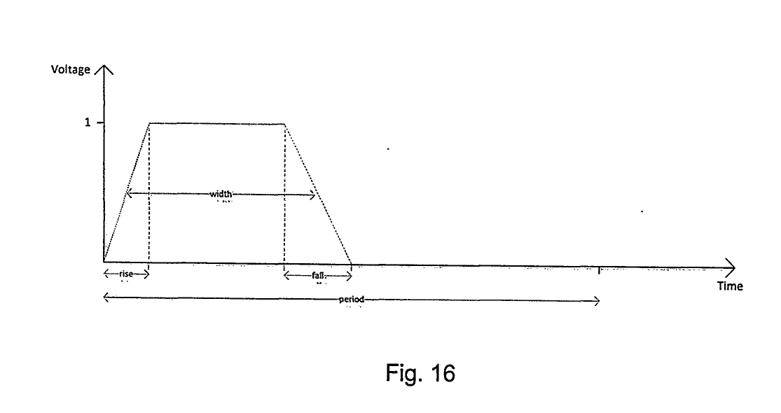

From simulations it has been shown that harmonic rejection is dependent on the rise/fall time of the LO-signal especially for a mixer that is shown in FIG. 8. Example of LO signal and its rise/fall time is shown at FIG. 16. In detail, the LO signal rises from 0 over a rise period (“rise”), then it is constant (1), and then it falls over a fall period (“fall”) to 0. It remains at 0 during the rest of the LO period. The rise period and the fall period may have the same duration or different durations. A width of the LO signal is defined at 50% level.

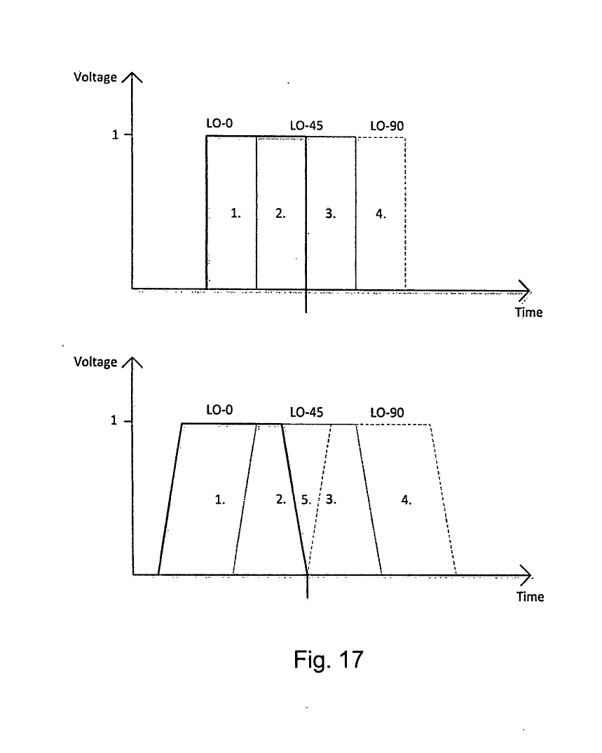

H3 rejection dependency on LO signal's rise/fall time can be understood by investigating LO phases that are shown at FIG. 17 and by looking for mixer configuration shown at FIG. 8. In the upper part of FIG. 17, a case with 0 rise time and 0 fall time is shown, while in the bottom part, rise time and fall time are finite (non-zero). In both cases, the duty cycle is 50%.

When LO signal phase 0° is active (high), during half of the time it is active (section 1. at the upper part of FIG. 17) there are no other phases active at the same time and hence, there is no loading for LO-0° (LO-0 hereinafter) mixer core. When LO-45° (LO-45 hereinafter) signal starts to be active there is also LO-0 phase active at the same time (section 2 at the upper part of FIG. 17), and when LO-0 signal deactivates at the same time LO-90 activates when LO-45 phase is still active (section 3 at the upper part of FIG. 17), and finally when LO-45 deactivates LO-90 is still active (section 4 at the upper part of FIG. 17).

Therefore LO-45 mixer core is exhibiting different loading than LO-0 and LO-90 mixer unit cells through common reference point which, in FIG. 8, is the BB input. This leads to different signal value for signal value LO-0/LO-90 mixer units and LO-45 mixer unit.

This is the root cause mechanism why LO signals rise/fall time will also have effect on harmonic rejection because depending on what is the rise/fall time it will change the LO-45 mixer core signal value relative to LO-0/LO-90 mixer cores. This can be seen from the bottom part at FIG. 17. Slower rise/fall time means that LO-45 signal value will differ more from the LO-0 and LO-90 signal values.

This difference can be compensated e.g. by using a kind of structure that is shown at the FIG. 12 or 14 where the correct amount of mixer cells may be selected that are used to produce each LO phase signal. Typically, a smaller or a larger number of cells to produce LO-45 signal may be used than it would be needed if the different LO signal cores wouldn't interact with each other. Furthermore, also LO-0 and LO-90 mixer signal values may differ from each other even though their LO signal behavior is the same. This can be caused by realistic impedance at the common reference node that will cause difference if signal is the first one in the LO phases or the last one like LO-0 and LO-90. When the first signal is activating there are most likely less charges present at the common reference node than there would be when the last signal is deactivating. Furthermore, a difference between LO-0 and LO-90 might be caused by a difference between rise time and fall time.

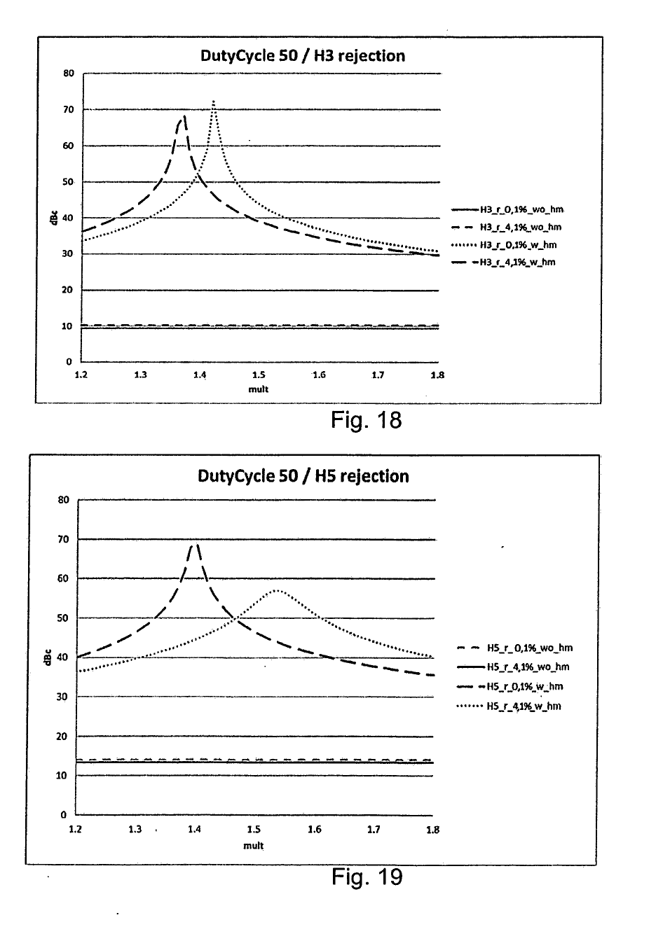

Next, examples of how much harmonic rejection can be achieved by tuning number of active elements are shown for different duty cycles and for 3^{rd} and 5^{th} harmonic in FIGS. 18 to 21. The value on the abscissa (“mult”) indicates the gain of the 45° mixer signal compared to the 0° and 90° mixer signals for cases with harmonic rejection (labeled “w_hm”). Also, results are shown for cases without harmonic rejection (labeled “wo_hm”), i.e. without a 45° branch. In the cases without harmonic rejection, there is—of course—no dependency on “mult”. The harmonic rejection on the ordinate is given in terms of dBc. In FIGS. 18 to 21, it is assumed that the rise time is as long as the fall time.

At FIG. 18 is shown 3^{rd} harmonic rejection in case of duty cycle 50 percent. Also results with and without harmonic rejection are shown as well with different rise/fall times (0.1% and 4.1%, indicated as “0.1%” and “4.1%”, respectively, in the labeling of the curves where % means a ratio of rise/fall time and period of the LO signal expressed as percentage value). Without harmonic rejection mixer, the level of the 3^{rd} harmonic for example is 9.5 dB which is in line with theory that says it's level should be 20*log 10(3). Which can also be seen is that by choosing appropriate tuning value for mixer units the 3^{rd} harmonic rejection level can be improved for levels of ˜70 dB which is a huge improvement. Also what can be seen is that for slower rise time (here: 4.1%) the weighting factor is below sqrt(2)=1.414 value.

At FIG. 19 is shown 5^{th} harmonic rejection in case of duty cycle 50 percent. Also results with and without harmonic rejection are shown as well as with different rise/fall times (0.1% and 4.1%). The labeling corresponds to that of FIG. 18. As can be seen from the figure, by choosing appropriate tuning value for mixer units the 5^{th} harmonic rejection level can be improved for levels of ˜55-70 dB. Also it can be seen that for slower rise time the weighting factor is now greater than sqrt(2)=1.414 value.

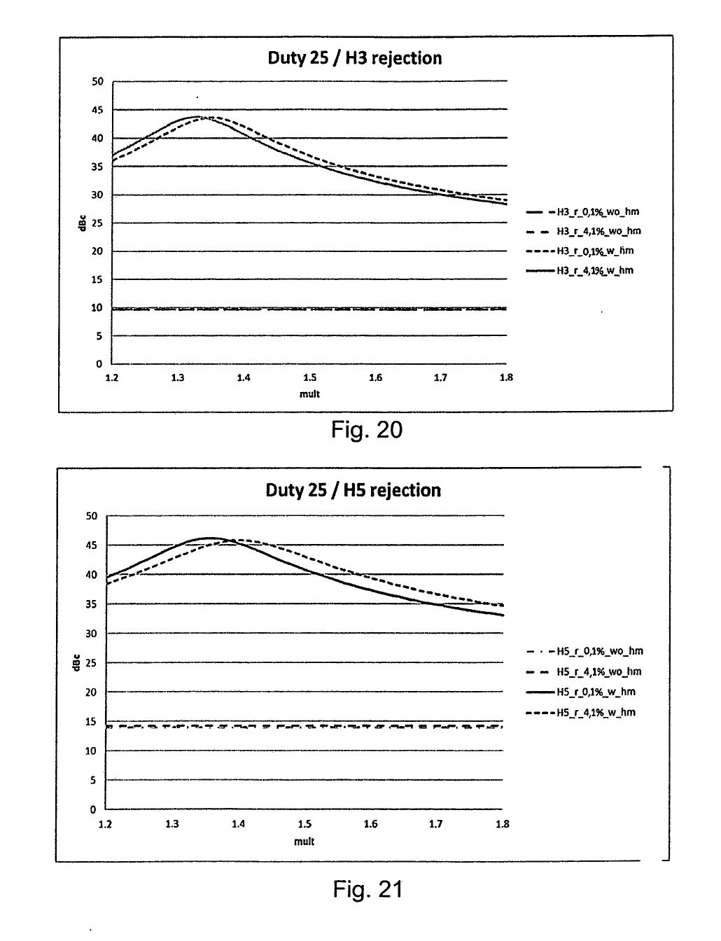

At FIG. 20 is shown 3^{rd} harmonic rejection in case of duty cycle 25 percent. Also results with and without harmonic rejection are shown as well with different rise/fall times (0.1% and 4.1%). The labeling is the same as according to FIG. 18. As can be seen, by choosing appropriate tuning value for mixer units the 3^{rd} harmonic rejection level can be improved for levels of ˜45 dB. Also, it can be seen that for duty cycle 25 percent 3^{rd} harmonic rejection variation due to rise/fall time variation is much smaller than for duty cycle 50 percent case (cf. FIG. 18).

At FIG. 21 is shown 5^{th} harmonic rejection in case of duty cycle 25 percent. Also results with and without harmonic rejection are shown as well with different rise/fall times (0.1% and 4.1%). The labeling is the same as according to FIG. 18. As can be seen, by choosing appropriate tuning value for mixer units the 5^{th} harmonic rejection level can be improved for levels of ˜45 dB. Also, it can be seen that for duty cycle 25 percent 5^{th} harmonic rejection variation due to rise/fall time variation is much smaller than for duty cycle 50 percent case (cf. FIG. 19).

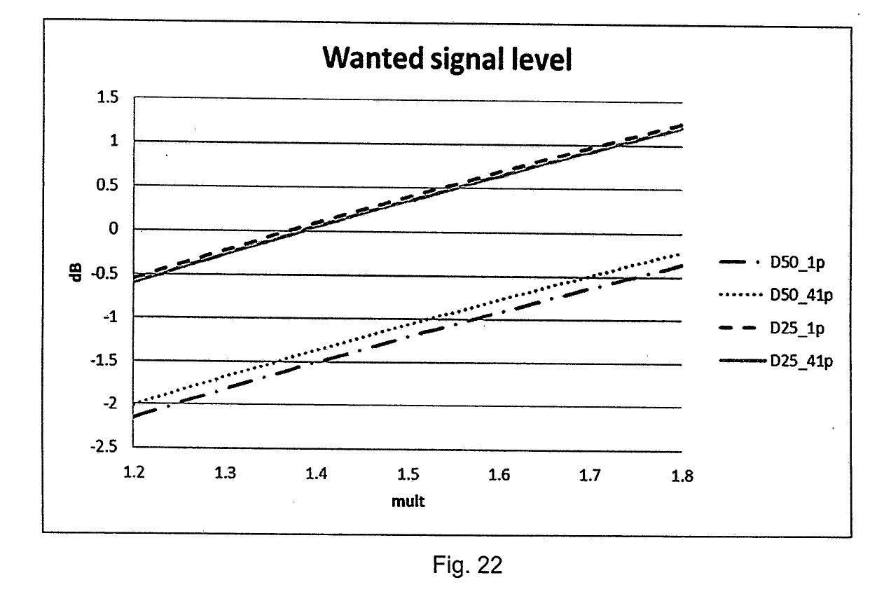

It is also noticed that for duty cycle 50 percent case the optimum values to have 3^{rd} harmonic rejection and for 5^{th} harmonic rejection differ significantly from each other but for duty cycle 25 percent case the optimum values vary much less, so when using duty cycle 25 percent tuning either one of the harmonics will also improve the other one greatly. Also, better rejection is achievable by using duty cycle 50 percent compared to using duty cycle 25 percent but in case of duty cycle 50 percent the wanted signal level is lower. Therefore, the harmonic rejection mixer with duty cycle 25 percent is actually able to produce more signal than that with duty cycle 50 percent, and that is shown at FIG. 22 (wanted signal is scaled such that 0 dB refers to normal non-harmonic rejection mixer with duty cycle 50 percent).

In detail, FIG. 22 shows the wanted signal level (the signal level of the carrier frequency or LO frequency) in dB dependent on “mult” as defined hereinabove for different duty cycles (50% and 25%, labeled as “D50” and “D25”, respectively) and rise/fall times (0.1% and 4.1%, labeled as “0.1%” and “4.1%”, respectively).

As an alternative, for compensation of the different signals, AGCs with different gains may be used.

Embodiments of the description comprise a method, wherein the level of an unwanted signal component (e.g. H3 or H5) is monitored, and the gain of at least one of the branches of the harmonic rejection mixer is adapted such that the level of the unwanted signal component is reduced.

Also, embodiments of the description comprise an apparatus, comprising a monitoring means (e.g. a monitoring processor) adapted to monitor the level of the unwanted signal component, and a control means (e.g. a control processor) adapted control the gain of at least one of the branches of the harmonic rejection mixer such that the level of the unwanted signal component is reduced.

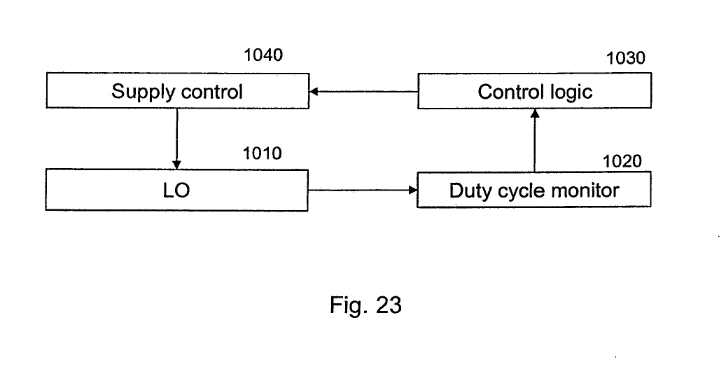

A feedback loop such as that shown in FIG. 23 may be used to improve the LO duty cycle variation due to rise/fall time variation of the LO signal. The LO 1010 provides its output signals (phase signals such as 0°, 45°, 90°, etc.) to a LO monitor 1020. In the LO monitor 1020, parameters of the duty cycle of the LO such as rise time, fall time, and amplitude are monitored. Depending on the value of the respective parameter(s) the control logic 1030 controls the supply control 1040. The supply control controls the supply voltage given to LO 1010.

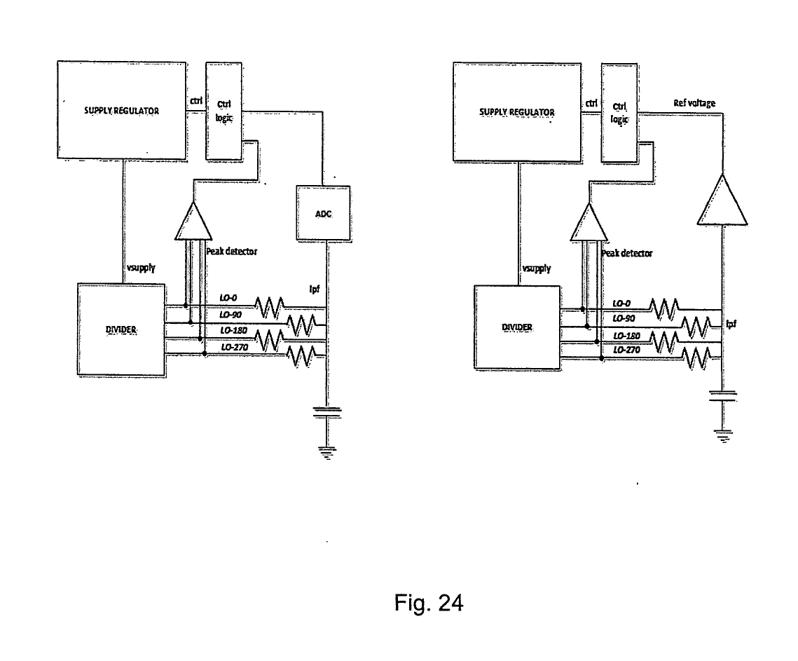

FIG. 24 shows example embodiments of a LO monitor. In this embodiment, LO is represented by a divider which receives clock signals from a (not shown) clock generator and generates the phase signals from the received clock signals. A low pass filter (LPF) is used to get a DC value of the averaged LO signal. In detail, all phases are low pass filtered and summed up. The resulting “lpf value” is directly related to LO signal duty cycle. By either using simple analog-to-digital converter (left part of FIG. 24) one may control divider supply voltage through programmable regulator, or by comparing this lpf voltage to known voltage value and produce analog voltage reference for supply regulator (right part of FIG. 24), Vsupply level may be controlled via CTRL logic (corresponding to control logic 1030) and supply regulator (corresponding to supply control 1040).

For example, if the LO amplitude is 1V and duty-cycle is 50%, the DC term should be 0.5V. But if the monitored DC values is larger than 0.5V, it is noticed that the LO waveform is not a square wave but has finite rise/fall slopes as shown in FIG. 16. Alternatively or in addition, the amplitude or duty-cycle of the LO might be varied from the targeted value(s). However, typically the duty-cycle varies less over the process corners, supply voltage, and temperature than the other parameters. The amplitude of the LO may be measured with an amplitude detector (gives rather linear DC value versus LO amplitude), which is another example embodiment of a LO monitor. As a result, the DC information at lpf node together with LO amplitude information can be used to monitor the slope of the LO.

By controlling supply voltage of Divider (Vsupply) one may adjust rise/fall times of the LO signal and when this property is combined with duty cycle information that one may have from the low pass filter one may tune LO duty cycle to match wanted value.

Controlling the divider supply voltage leads to another useful property. LO waveform is heavily dependent on process corner and temperature (sharp transitions in cold temperature and in fast process corner). Thus, in fruitful conditions, the LO transitions could be slowed down and still feasible performance could be achieved. That can be achieved by decreasing the supply voltage which also results in current consumption saving. Alternatively, in worse conditions (in hot and slow process corner) there could be a need to sharpen the waveform thus requiring higher supply voltage and increased current consumption. As a result, with DC component monitor, the LO waveform can be made more constant over process and temperature ranges and optimized current consumption is achieved. Thus, “overdesign” can be avoided (design to meet the performance in the worst case conditions.)

LO may generate its frequency (carrier frequency) directly, or by frequency dividing or frequency multiplying of another directly generated signal.

Embodiments of the invention are shown with three paths (0°, 45°, and 90°). However, other embodiments may comprise two paths, or four or more paths with different LO phases applied.

Embodiments of the invention may be employed in senders and/or receivers of network elements of a 3GPP network. They may be employed also in senders and/or receivers of other mobile networks such as CDMA, EDGE, UMTS, LTE, LTE-A, GSM, WLAN networks, etc, and also in other senders and/or receivers. In particular, they may be deployed in a terminal (terminal device, user equipment) of the respective technology which may be e.g. a mobile phone, a smart phone, a PDA, a laptop or any other terminal. Also, they may be deployed in base stations of the respective technology such as eNodeB, NodeB, BTS, Access Point etc.

Names of network elements, protocols, and methods are based on current standards. In other versions or other technologies, the names of these network elements and/or protocols and/or methods may be different, as long as they provide a corresponding functionality.

The figures show logical or functional structures of example embodiments. They are not intended to show an arrangement of the components on a circuit board, substrate, etc. I.e., the arrangement of the components may or may not correspond to the logical or functional structure.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware.

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

Such hardware may be hardware type independent and may be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. MOS components (e.g. transistors) may be implemented in NMOS or PMOS technology. Different MOS components may be based on the same or different of these technologies.

A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a hardware-based processor. A device may be regarded as a device/apparatus or as an assembly of more than one device/apparatus, whether functionally in cooperation with each other or functionally independently of each other. The components of a device may be in a same device housing or in different device housings.

For example, method steps may be implemented in software, firmware, or hardware, in the latter case using any known or future developed hardware technology or any hybrids of these, as described hereinabove. The method steps may be implemented in a mixture of software, firmware, and hardware.

Various embodiments of a UE may include, but are not limited to, mobile stations, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

As used in this application, the term “circuitry” refers at least to each of the following:
a) to hardware-only circuit implementations (such as implementations in only analog and/or digital circuitry), and
b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions), and
c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

It is to be understood that what is described above is what is presently considered the preferred embodiments of the present invention. However, it should be noted that the description of the preferred embodiments is given by way of example only and that various modifications may be made without departing from the scope of the invention as defined by the appended claims. That is, the above embodiments are to be understood as illustrative examples of the invention. Further embodiments of the invention are envisaged.

1. An apparatus comprising:
a local oscillator configured to oscillate at a carrier frequency and having plural output ports, wherein the local oscillator is configured to provide a signal of a respective phase at each of the plural output ports, wherein the respective phases are different from each other;
a plurality of branches, wherein each branch corresponds to one of the plural output ports and comprises a mixer unit, wherein, for each branch, the signal of the respective phase is applied to an input port of the mixer unit and the mixer unit is configured to modulate a baseband signal by the signal of the respective phase of the local oscillator to obtain, at its output port, a respective modulated signal; and
a combiner configured to add the modulated signals from the branches to obtain a total signal to be output to a load; wherein
at least one of the branches comprises a multi-switch, wherein for each of the at least one multi-switches:
an output terminal of the multi-switch is connected to the respective input port of the mixer unit,
the multi-switch comprises plural input terminals and is configured to connect one of the input terminals to the output terminal and to disconnect the others of the input terminals from the output terminal, and
each of the input terminals is connected to one of the output ports of the local oscillator.

2. The apparatus according to claim 1, wherein
at least one of the mixer units comprises a sub-combiner and plural sub-branches, wherein each of the sub-branches comprises a mixer sub-unit and an on-off switch; wherein for each of the mixer units comprising the sub-combiner:
each of the mixer sub-units is configured to modulate the baseband signal by the signal of the respective phase of the local oscillator to obtain a modulated signal of the mixer sub-unit, and
the sub-combiner is configured to add the modulated signals of the mixer sub-units to obtain the modulated signal of the branch; and
for each of the sub-branches the on-off switch is configured to switch on and to switch off the modulated signal of the respective mixer sub-unit.

3. The apparatus according to claim 2, wherein the on-off switch is an enabling switch configured to connect and disconnect the signal of the respective phase of the local oscillator from the respective mixer sub-unit, and/or wherein the on-off switch is a gain control transistor, wherein one of a source and a drain of the gain control transistor of the respective sub-branch is connected to the respective mixer sub-unit, and the other one of the source and the drain of the gain control transistor is connected to the respective sub-combiner.

4. The apparatus according claim 1, wherein
at least one branch comprises a gain control transistor, and one of a source and a drain of the gain control transistor is connected to the output port of the respective mixer unit and the other of the source and the drain is connected to the combiner.

5. The apparatus according to claim 3 comprising at least one gain control transistor, wherein a gain between the source and the drain of the gain control transistor is configurable.

6. The apparatus according to claim 1, wherein
at least one of the plurality of branches comprises a weighting circuitry configured to increase and decrease the modulated signal of the respective branch; and the apparatus further comprises:
a detecting circuitry configured to detect if the total signal comprises a frequency component of a frequency different from the carrier frequency with a level higher than a predefined level; and
a controller adapted to control the at least one weighting circuitry in order to reduce the level of the frequency component below the predefined level.

7. A method applied to a monitored apparatus, wherein the monitored apparatus comprises plural branches and each branch is adapted to modulate a baseband signal with a signal of a local oscillator of a respective phase to obtain a respective modulated signal of the branch and the respective phases are different from each other, a combiner to combine the modulated output signals of the branches into a total signal, and at least one of the branches comprises a weighting circuitry adapted to weight the respective modulated signal, wherein the method comprises:
detecting if the total signal comprises a frequency component of a frequency different from the carrier frequency with a level higher than a predefined level; and
adapting, by the weighting circuitry, the modulated signal of the at least one branch comprising the weighting circuitry in order to reduce the level of the frequency component.

8. The method according to claim 7, wherein the monitored apparatus further comprises a gain control transistor, wherein a gain between a source and a drain of the gain control transistor is configurable, and the weighting circuitry comprises the at least one gain control transistor.

9. The method according to claim 7, wherein at least one of the plural branches of the monitored apparatus comprise an apparatus according to any of claims 1 to 5, and the weighting circuitry comprises the at least one multi-switch.

10. The method according to claim 7, wherein the monitored apparatus further comprises at least one enabling switch, the enabling switch configured to switch on and to switch off the respective modulated signal, and the weighting circuitry comprises the at least one enabling switch.

11. An apparatus, comprising:
plural branches, wherein each branch is adapted to modulate a baseband signal with a signal of a local oscillator of a respective phase to obtain a respective modulated signal of the branch and the respective phases are different from each other, and at least one of the branches comprises a weighting circuitry adapted to weight the respective modulated signal;
a combiner adapted to combine the modulated output signals of the branches into a total signal,
a detector adapted to detect if the total signal comprises a frequency component of a frequency different from the carrier frequency with a level higher than a predefined level; and
a controller adapted to control the weighting circuitry in order to reduce the level of the frequency component below the predefined level.

12-13. (canceled)

14. The apparatus according to claim 1, wherein the apparatus is deployed in a base station.

15. The apparatus according to claim 1, wherein the apparatus is deployed in a user terminal.

16. The apparatus according to claim 1, wherein the apparatus is deployed in a transceiver.

17. The method of claim 7, the method further comprising controlling the weighting circuitry in order to reduce the level of the frequency component below the predefined level.

18. The method according to claim 7, wherein the method is performed by a user terminal.

19. The method according to claim 7, wherein the method is performed by a base station.

20. The apparatus of claim 11, wherein
each branch comprises a mixer unit and at least one of the branches comprises a gain control transistor; and
one of a source and a drain of the gain control transistor is connected to the respective mixer unit, and the other of the source and the drain of the gain control transistor is connected to the combiner.

21. The apparatus according to claim 11, wherein the apparatus is deployed in a user terminal.

22. The apparatus according to claim 11, wherein the apparatus is deployed in a base station.
